(19) United States
(12) Patent Application Publication
(10) Pub. No.: US 2012/0325160 A1
(43) Pub. Date: Dec. 27, 2012

(54) EXTRA HEAVY DUTY ABSORBENT PADS TO ABSORB DOG URINE AND FECES

(75) Inventor: David Goldberg, Marina Del Rey, CA (US)

(73) Assignee: PETKIN, INC., Marina Del Rey, CA (US)

(21) Appl. No.: 13/526,222

(22) Filed: Jun. 18, 2012

Related U.S. Application Data
(60) Provisional application No. 61/571,471, filed on Jun. 27, 2011.

(51) Int. Cl. A01K 29/00; A01K 1/015; B32B 9/02; B32B 5/02; D21H 11/00

(52) U.S. Cl. 119/171; 428/221; 428/354; 162/100; 428/532

(57) ABSTRACT

An absorbent pad which contains five separate layers of fabric which include as a central layer, bamboo ingredients that are instrumental in absorbing the moisture and eliminating odor and germs from animal urine and feces.

This patent application claims priority to Provisional Application Ser. No. 61/571,471 filed on Jun. 27, 2011.

### BACKGROUND OF THE INVENTION

1. Field of the Invention

The present invention relates to sanitary coverings which are used to cover the floor of a home so that a family pet such as a dog can be encouraged to urinate and defecate on the specific sanitary pad which will absorb the moisture from the urine and feces and absorb the odor from the urine and feces and permit the pad to be disposed of in an efficient way while not soiling the surface of the owner's floor.

2. Description of the Prior Art

In general, absorbent pads are known in the prior art but the present inventor is unaware of any unique absorbent pad which contains the unique features of the present invention.

### SUMMARY OF THE INVENTION

The present invention is an absorbent pad which contains five separate layers of fabric which include as a central layer, bamboo ingredients that are instrumental in absorbing the moisture and eliminating odor and germs from animal urine and feces.

It has been discovered, according to the present invention, that the use of bamboo extract in any form such as liquid form or spray form can be used as a spray onto absorbent pads and the bamboo extract will serve to eliminate urine and feces odor and germs from the pad that contain bamboo extract.

It has further been discovered that bamboo pulp material can also be used as a pulp filling for the pad by itself or mixed with any other various pulp materials common in the art. Bamboo fibers of any kind can also be used including non-woven fabrics made with bamboo fibers.

It is therefore an object of the present invention to provide an absorbing pad which contains thereon bamboo extract either in a spray form or liquid form which has been sprayed onto one or more of the layers of the fabric pad in addition to the central layer which contains bamboo ingredients as the primary feature of the present invention to help absorb urine and feces and eliminate related odors and germs.

It is a further object of the present invention to provide a method to affix the pad to a location where an animal will know to go and urinate at the same time and which will prevent the pad from being moved.

It is a further object of the present invention to provide a layer which prevents the animal from tracking urine, feces and excrement from the location of the pad to any other location in the premises.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a perspective exploded view of the present invention.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

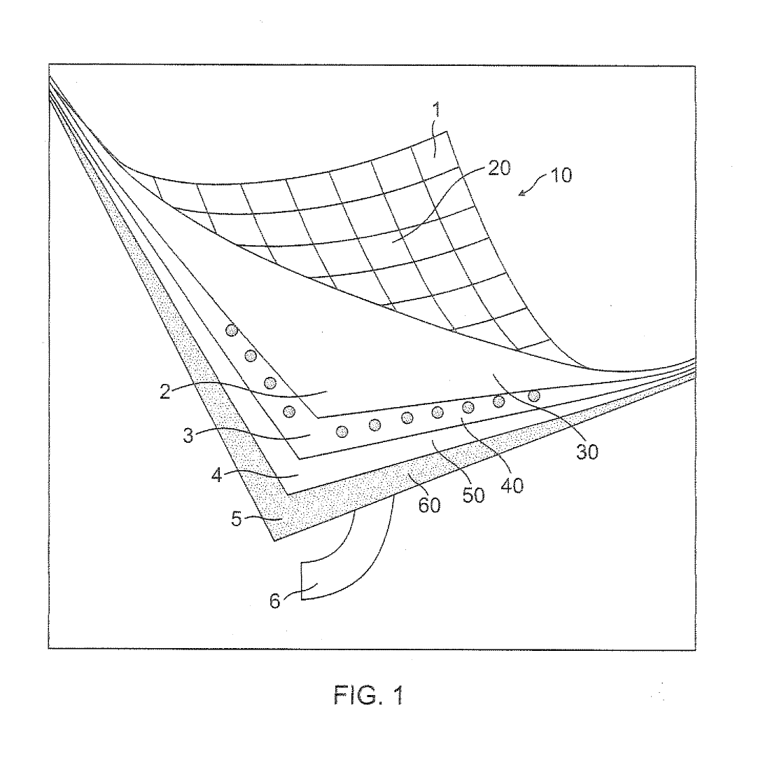

Referring to FIG. 1, the present invention includes a five layer pad 10 which can be placed on a floor in order to encourage an animal such as a dog to urinate on the pad. The upper layer 1 is a quick drying, tear-resistant top sheet which keeps the animal's paws dry and prevents the animal from tracking urine or feces around the house. The second layer 2 is an absorbent layer which pulls liquid into the third super absorbent bamboo layer. The third layer 3 which is the heart of the present invention is a triple action, super-absorbent bamboo core. It absorbs up to four cups of liquid (32 ounces/900 milliliters) with the natural power of bamboo plus super absorbent polymers. The bamboo core layer destroys odors and germs with bamboo's natural deodorizing and antimicrobial properties, not chemicals. It attracts pets in two ways, namely with bamboo grass essences and pheromones. The fourth layer 4 is an extra absorbent layer which locks in excess moisture for added protection and is underneath the bamboo core layer. The fifth and final layer 5 is a plastic backing which comprises adhesive strips 6 on the back to hold the pad in place. It has sealed edges and plastic backing to prevent leaking and protects the floors. Therefore, the present invention is a unique absorbent pad which contains five layers, the most important layer of which is the central bamboo core layer that helps to absorb the moisture from animal feces and urine and also eliminates the odor and germs.

To utilize the present invention, the user unfolds the pad 10 and peels off four adhesive strips 6 at each corner of the plastic lower surface side 5 and places the pad on the floor (away from food and bedding) with the absorbent side up and the plastic side having the adhesive strips on the bottom so that the pad is affixed to the floor. The user then presses firmly so that the pad remains affixed to the floor.

It is also advisable to place an animal attractant onto the upper surface 1 of the pad 10 on the upper layer so that the animal is attracted to the pad. Once the pet relieves itself on the pad, the pet is rewarded for good behavior. The used pad is then disposed of in the trash can and replaced with a new pad. The present invention makes puppy house training easier for an indoor pet. The owner should start by using pads indoors. Once the pet is successfully trained indoors, the puppy can be trained to relieve itself outdoors by moving the pad to an outdoor location. A clean pad can be kept indoors for times when the owner is away and the animal is locked indoors.

The present invention is especially beneficial for adult dogs, indoor dogs, traveling dogs and ailing and aging dogs. The pads can be used at any stage of a pet's life. They are essential for pets who do not regularly have access to the outdoors to relieve themselves. The pad is also great for travel in cars, hotels, pet carriers and more where the animal can relieve itself and the urine and feces can be absorbed as discussed above.

The amazing ecological benefits of bamboo grass is that it is self-regenerating and grows up to four feet per day. It is also inherently organic requiring zero pesticides or chemical fertilizers to grow. Bamboo traps carbon and creates oxygen cleaning the air of pollutants and toxins.

In addition to the central bamboo core which has the bamboo enhanced pulp material 3, bamboo extract such as 20 can be sprayed onto any one of the layers from the top most sheet 1 to the bottom plastic sheet 5. The bamboo extract in liquid or spray form is shown as 20 on top sheet 1 and is shown as 30 on second sheet 2, is shown as 40 on third sheet 3, is shown as 50 on fourth sheet 4, and is shown as 60 on fifth sheet 5. It will be appreciated that the bamboo extract in either liquid form or spray form can be placed on any one or more of the layers 1, 2, 3, 4, 5 to help supplement the bamboo enhanced pulp material in layer 3.

A further benefit of the invention is that it utilizes natural bamboo material. Bamboo is self-regenerating and grows up to four feet (122 centimeters) per day and it is inherently organic requiring zero pesticides or chemical fertilizers to grow. The carbon sequestration traps carbon and creates oxygen cleaning the air of pollution and toxins.

In addition, the present invention works better in five distinct ways:

1. It is quick drying and prevents tracking, and leak proof protection of the floors.

2. It absorbs with bamboo power and super absorbent polymers.

3. Bamboo's natural deodorizing and antimicrobial properties destroys odors and germs.

4. It attracts pets with bamboo grass essences and pheromones

5. The adhesive strips hold the pad in place so it will not move from its location where it has been placed on the floor.

Therefore, through use of the present invention, the owner's home can remain free and clear of urine and animal feces by encouraging the owner's dog to urinate and defecate on the specific unique pad which contains the five layers as discussed above.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A pad used to encourage an animal to urinate and defecate feces on the pad, the pad comprising:
a. a top sheet layer made of quick drying tear resistant material which keeps the animal's paws dry and keeps the animal from dragging urine and feces away from the pad;
b. a second sheet layer made of absorbent material which pulls liquid into a third layer;
c. the third layer made of a super absorbent bamboo core which has the ability to absorb up to 32 ounces of liquid, the bamboo core destroying odor and germs;
d. a fourth sheet layer made of material which locks in excess moisture for added protection and rests under the bamboo core layer;
e. a fifth layer made of plastic backing which includes adhesive strips affixed to a rear surface of the fifth layer to hold the pad in place on a horizontal surface and having a sealed circumferential edge to prevent leaking; and
f, the five layers resting on top of each other, the first top sheet layer resting on the second sheet layer, the second sheet layer resting on the third layer, the third layer resting on the fourth sheet layer and the fourth layer resting on the plastic backing, all five layers formed in the same width and length size and shape.

2. The pad in accordance with claim 1, further comprising enhanced bamboo pulp material.

3. The pad in accordance with claim 1 further comprising bamboo extract spray applied onto at least one of the five layers.

4. The pad in accordance with claim 1 further comprising bamboo extract liquid applied onto at least one of the five layers.

5. The pad in accordance with claim 1 further comprising bamboo extract spray applied onto each of the five layers.

6. The pad in accordance with claim 1 further comprising bamboo extract liquid applied onto each of the five layers.

7. The pad in accordance with claim 1 further comprising:
a. the first sheet layer is affixed to the second sheet layer;
b. the second sheet layer is affixed to the third layer;
c. the third layer is affixed to the fourth sheet layer; and
d. the fourth sheet layer is affixed to the fifth layer.

8. A multilayer pad, comprising:
a. a top fabric layer made of quick drying tear resistant material;
b. a second layer made of absorbent material;
c. a third layer made of bamboo core;
d. a fourth layer having the ability to lock in excess moisture;
e. a fifth layer made of backing material; and
f. the top fabric layer resting on top of the second layer, the second layer resting on top of the third layer, the third layer resting on top of the of the fourth layer, the fourth layer resting on top of the fifth layer, the five layers affixed together to form the multilayered pad.

9. The multilayered pad in accordance with claim 8, further comprising:
a. the fifth layer having a rear surface including adhesive means to enable the multilayered pad to be affixed to a horizontal surface.

10. The multilayered pad in accordance with claim 8 further comprising bamboo extract spray applied onto at least one of the five layers.

11. The multilayered pad in accordance with claim 8 further comprising bamboo extract liquid applied onto at least one of the five layers.

12. An absorbent pad comprising several layers of fabric including bamboo ingredients in at least a central layer, the bamboo ingredients instrumental in absorbing moisture and eliminating odor and germs from animal urine and feces.

13. A pad comprising bamboo pulp material used as a pulp filling for the pad.

14. A pad comprising material at least partially made of bamboo fibers.

15. An absorbent pad comprising:
a. a multiplicity of layers of material; and
b. at least some of the layers of material contain thereon bamboo extract selected from the group consisting of spray form and liquid form.

16. The absorbent pad in accordance with claim 15, further comprising at least one layer containing bamboo ingredients.
